(19) United States
(12) Patent Application Publication
(10) Pub. No.: US 2026/0058458 A1
(43) Pub. Date: Feb. 26, 2026

(54) Method for Compensating for Ambient Light for an Arc Flash Detection System for an Electrical Equipment and Arc Flash Detection System for an Electrical Equipment

(71) Applicant: ABB Schweiz AG, Baden (CH)

(72) Inventors: A Ravishankar, Bangalore (IN); Samir Mistry, Maharashtra (IN); Arinjai Gupta, Bengaluru (IN); Sreenivas Ranganath, Bangalore (IN); Pavan Narendra, Bangalore (IN); Mital R. Pawar, Bangalore (IN)

(73) Assignee: ABB Schweiz AG, Baden (CH)

(21) Appl. No.: 19/372,419

(22) Filed: Oct. 29, 2025

Related U.S. Application Data
(63) Continuation of application No. PCT/IB2023/054554, filed on May 2, 2023.

(51) Int. Cl. H02H 1/00; G01J 1/02; G01J 1/42

(52) U.S. Cl. CPC H02H 1/0023; G01J 1/0228; G01J 1/4204; H02H 1/0069; H02H 1/0092

(57) ABSTRACT

A method for compensating for ambient light for an arc flash detection system for an electrical equipment, the arc flash detection system including a first optical sensor for detecting an arc flash, the method comprising initiating a recording mode in which a first output signal of the first optical sensor is recorded, wherein recording the first output signal comprises storing a first plurality of values, wherein each value of the first plurality of values is representative of a level of ambient light condition in or around the electrical equipment; terminating the recording mode after a recording time period; determining, based on the first plurality of values, a first quantity characterizing ambient light in or around the electrical equipment; and configuring the arc flash detection system to compensate for ambient light based on the first quantity.

### CROSS-REFERENCE TO RELATED APPLICATIONS

The instant application claims priority to International Patent Application No. PCT/IB2023/054554, filed May 2, 2023, which is incorporated herein in its entirety by reference.

### FIELD OF THE DISCLOSURE

The present disclosure generally relates to detection systems for electrical equipment and, more particularly, to systems and methods for detecting arc flashes.

### BACKGROUND OF THE INVENTION

Electrical arcing occurs when a discharge of electricity is produced during an electrical breakdown of gases within the air. This discharge is continuous rather than momentary, which is what separates an electrical arc from an electric spark. The current's intended path becomes disrupted, and it will instead travel between two points, either from one conductor to another, or to a grounded object nearby. When this happens, the conduction of electrical current is uncontrolled and the surrounding air is ionized.

The point of the arc produces extreme light and heat, and this is known as the arc flash. Electrical arcing may take place due to accidental contact with equipment that is energized, breaks or gaps in insulation, exposed and frayed wires, equipment failure, regular wear and tear on the conductor's surface, overloaded outlets, impurities such as corrosion and dust, electrical equipment and systems that are insufficiently maintained.

Arc flashes may occur in electrical panels, switchboards, motor control centers, transformers, damaged wires, metal clad switchgears, fused disconnectors, and other types of electrical equipment, with copper or aluminum conductors, busbars, contacts on motor contactors, and breaker contacts. In small (2 kA) arc flash events, the measured light intensity can be in the order of a million lux at a distance of 1 meter from the arc flash source; for larger arcing currents (e.g., 20 kA), arc flash light intensities may be in the order of 10 million lux at a distance of 1 meter from the arc flash source.

A protective relay is a relay device designed to trip a circuit breaker when a fault is detected. Arc flash relays can detect a developing arc flash and send a trip signal to the circuit breaker, which reduces clearing time and damage. In an example, an arc flash relays detects an arc flash when its sensor captures a level of light intensity that is greater than a trip level. While an arc flash light intensity may be large, only some of the arc flash light strikes the sensor. Thus, the trip level needs to be set appropriately.

Many arc flash relays use light sensors with fixed detection thresholds, set for example between 3,000 to 10,000 lux light intensity. With this light sensor setting, it is intended that the relay will not nuisance trip on everyday bright lights such as the light from an LED flashlight or the flash from a mobile phone camera. Nevertheless, the setpoint is sometimes raised to reduce nuisance tripping. For example, opening a switchgear cabinet to direct sunlight, incandescent lighting or fluorescent lighting, can set off the arc flash relay inadvertently, which can cause costly downtime. However, this in turn may unnecessarily reduce the sensitivity of the system to a real arc flash.

Document US 2010/0328824 A1 describes an arc flash detector. The document describes that radiation sensors tend to be sensitive to relatively low light levels and so, when employed to detect radiation associated with an arc flash event, they will tend to detect non arc flash radiation, so called “nuisance light, such as sunlight, flash lights and room lights, which vary in intensity from about 500 lux (flashlight) to about 2,000 lux (commercial space lighting) to about 80,000 lux (direct sunlight). The document further describes that while direct sunlight can be as strong as 80,000 lux, it is unlikely to strike the detector in a typical usage environment, so a lower minimum intensity, such as about 50,000 lux, is sufficient to detect all arc flashes while eliminating detection of nuisance light, in embodiments. In other examples, a minimum intensity of about 10,000 lux is effective.

In view of the above, arc flash detection systems face the challenge of nuisance trips triggered by ambient light.

### BRIEF SUMMARY OF THE INVENTION

Embodiments described herein relate to a method of compensating for ambient light for an electrical equipment arc flash detection system, the electrical equipment arc flash detection system including a first optical sensor for detecting an arc flash. Further embodiments relate to an electrical equipment arc flash detection system comprising a data processing apparatus comprising means adapted to carry out the method of compensating for ambient light for an electrical equipment arc flash detection system. Still further embodiments relate to a computer program comprising instructions which, when the program is executed by a computer, cause the computer to carry out the method of compensating for ambient light for an electrical equipment arc flash detection system.

In one aspect, there is provided a method for compensating for ambient light for an arc flash detection system for an electrical equipment, the arc flash detection system including a first optical sensor for detecting an arc flash, the method comprising: initiating a recording mode in which a first output signal of the first optical sensor is recorded, wherein recording the first output signal comprises storing a first plurality of values, wherein each value of the first plurality of values is representative of a level of ambient light condition in or around the electrical equipment; terminating the recording mode after a recording time period; determining, based on the first plurality of values, a first quantity characterizing ambient light in or around the electrical equipment; and configuring the arc flash detection system to compensate for ambient light based on the first quantity.

In an aspect, there is provided an arc flash detection system for an electrical equipment, the arc flash detection system comprising a data processing apparatus comprising means adapted to carry out the method as described herein. In a further aspect, there is provided a computer program comprising instructions which, when the program is executed by a computer, cause the computer to carry out the method as described herein.

### BRIEF DESCRIPTION OF THE SEVERAL VIEWS OF THE DRAWING(S)

FIG. 1 is a perspective diagram of an embodiment of an electrical equipment arc flash detection system according to the present disclosure.

FIG. 2 is a block diagram of an embodiment of an arc flash detection system according to the present disclosure.

FIG. 3 is a block diagram illustrating an embodiment of a multi-sensor arc flash detection system according to the present disclosure.

FIG. 4 is a flow diagram of an exemplary embodiment of a method for compensating for ambient light for an electrical equipment arc flash detection system according to the present disclosure.

### DETAILED DESCRIPTION OF THE INVENTION

Within the following description of the drawings, the same reference numbers refer to the same or to similar components. Generally, only the differences with respect to the individual embodiments are described. Unless specified otherwise, the description of a part or aspect in one embodiment applies to a corresponding part or aspect in another embodiment as well.

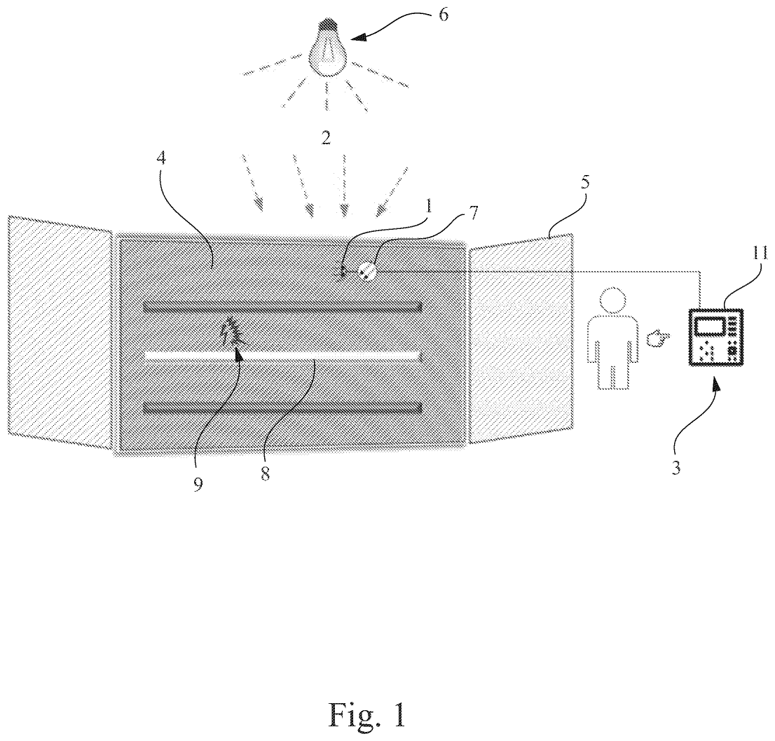

FIG. 1 illustrates an embodiment of an electrical equipment arc flash detection system according to the present disclosure. An arc or arc flash 9 is created when an electrical fault, for example due to insulation failure or a short circuit, occurs. An optical sensor 1 can be used for arc detection, in particular in each chamber or compartment or module in an electrical equipment 4 such as an electrical switchboard. A system for detecting arc flash may be understood as a system for detecting arc or arc fault, and vice versa.

Examples of electrical equipment 4 are electrical panels, switchboards, motor control centers, transformers, damaged wires, (metal clad) switchgears, (fused) disconnectors, and other types of electrical equipment, with copper or aluminum conductors, busbars 8, contacts on motor contactors, and breaker contacts. An optical sensor may be understood as a device that converts light signal to electrical signal. An optical sensor may be understood to include at least one of a fiber optic loop sensor and a point sensor. An optical sensor 1 may comprise a fiber optic cable. The optical sensor 1 may be of a first length (in meters). The first length of the optical sensor may be determined onsite, e.g. after manufacturing and/or assembly of the optical sensor.

In the context of the present disclosure, an optical sensor 1 that is exposed to ambient light 2 can cause false detection of arc and can trip the breaker. Ambient light changes can be caused by an opening of the busbar chamber, a flash from high intensity torch light during inspection by an engineer, exposure to sunlight during the day, and/or changes in ambient light level in the room, e.g. in the switchgear room. Providing a factory-defined or user-defined light threshold for ambient light for optical sensors for arc flash detection systems for electrical equipment 4 has limitations. In particular, the optical sensor is not easily well adjusted for site specific conditions (and the resulting condition combinations), such as on-site illumination type and level (for example tungsten light sources, halogen light sources, incandescent, sunlight), range of sunlight levels throughout the day/year, exposed fiber optic length, optical sensor/fiber optic position/orientation (relative to potential arc flash locations) as installed on-site, optical sensor output level for a given incident light intensity (e.g. as a function of fiber optic length), fiber optic cable type, optical lens type (which are choices which may be determined only on-site), and uncontrolled variation in sensors (the sensors being of same type/length).

Non-limiting examples of sensor output level for various light source types, for a given incident light intensity are shown in the following Table 1. As seen, sensor output level can vary according to illumination type.

TABLE 1
Sensor output level for various light source types.

| Light intensity | Light sensor output (mV) for various light source types | | |
|---|---|---|---|
| (lux) | Halogen | LED | Incandescent |
| 1000 | 4 | 1 | 5 |
| 2000 | 12 | 3 | 15 |
| 3000 | 24 | 8 | 25 |
| 4000 | 29 | 12 | 32 |
| 5000 | 43 | 15 | 38 |
| 6000 | 52 | 16 | 43 |
| 7000 | 61 | 27 | 49 |
| 8000 | 96 | 37 | 64 |
| 9000 | 82 | 47 | 70 |
| 10000 | 90 | 56 | 78 |

Non-limiting examples of sensor output level for various fiber optic cable lengths, for a given incident light intensity are shown in the following Table 2. As seen, sensor output level can vary according to fiber optic cable lengths.

TABLE 2
Sensor output level for various fibre optic cable lengths.

| | Light sensor output (mV) for | | |
|---|---|---|---|
| | various fibre optic cable lengths | | |
| Light intensity | 1 metre | 5 metre | 15 metre |
| (lux) | (mV) | (mV) | (mV) |
| 1500 | 4 | 2 | 1 |
| 3000 | 10 | 8 | 2 |
| 5000 | 19 | 16 | 5 |
| 7000 | 28 | 23 | 9 |
| 10000 | 42 | 33 | 22 |
| 15000 | 62 | 51 | 22 |

Non-limiting examples of sensor output level for various sensors of a given type and length, for a given incident light intensity are shown in the following Table 3. As seen, sensor output level can vary even when the sensors are of the same type and length.

TABLE 3
Sensor output level for various sensors
of a given sensor type and length.

Light sensor output (mV) for various sensors
of a given sensor type and length (5 metre)

| Light intensity | Sensor A | Sensor B |
|---|---|---|
| (lux) | (mV) | (mV) |
| 1000 | 1 | 1 |
| 2000 | 2 | 3 |
| 3000 | 5 | 6 |
| 4000 | 8 | 10 |
| 5000 | 10 | 13 |
| 6000 | 14 | 17 |
| 7000 | 16 | 20 |
| 8000 | 19 | 23 |
| 9000 | 22 | 26 |
| 10000 | 24 | 30 |

The inventors have discovered a method for overcoming the above-described limitations of factory-defined or user-defined light threshold for ambient light 2 for optical sensors for arc flash detection systems for electrical equipment 4, aspects of which are described in further detail herein. In the following is a brief description relating to general aspects, followed thereafter by more specific embodiments.

An arc flash detection system may be understood to be in a (final or installed) onsite condition. The arc flash detection system may be configured to compensate for ambient light 2 (conditions).

The arc flash detection system comprises at least a first optical sensor 1. The arc flash detection system may comprise a plurality of optical sensors, e.g. the first optical sensor 1 and a second optical sensor 10. The second optical sensor 10 may be in the same compartment or chamber (at a different location to the first optical sensor 1) or in a different compartment or chamber.

The first optical sensor 1 may be understood to be in a (final) installed condition, e.g. in a fixed position, of a given type, of a given length, and/or in a condition ready for physical operation.

In an example, the compensation method includes an initiation step that starts a recording window. In an example, during the recording window, ambient light level as seen by the (first) optical sensor 1, 10 is recorded. In an example, during the recording window, parameter(s) of ambient light, and/or ambient light changes are recorded. In an example, during the recording window, parameter(s), such as light intensity level (and corresponding time of at which said light intensity level is detected), as detected by the (first) optical sensor 1, 10, is recorded.

The term recording may be understood as receiving and storing. For example, recording ambient light changes may be understood as receiving and storing a first output signal of the first optical sensor 1, and/or receiving and storing a first plurality of values (wherein the first output signal or each value of a first plurality of values is representative of a level of ambient light condition in or around the electrical equipment 4). The first plurality of values may be understood as being of the first output signal. The first output signal may comprise a date and/or time value for each of the first plurality of values.

In an example, during the recording window, the sensor detects a plurality of ambient light conditions and/or ambient light intensities, and outputs a first signal or a first plurality of values representative of the plurality of ambient light conditions and/or ambient light intensities. In an example, parameter(s) of ambient light condition includes at least one of a first output of the first optical sensor 1 (e.g. in millivolts), in particular as a function of date and/or time.

The recording window is terminated based on at least one of the following: a fixed recording time duration, a user-defined recording time duration, a manual/user-determined termination of the recording, and/or a characteristic of the ambient light level recorded thus far.

For example, a first range of a first portion of ambient light level recorded is within a second range of a second portion of ambient light level, the second portion being recorded after the first portion. In an example, a time duration of the first portion exceeds a minimum value, such as 1 hour, 1 day or 1 week. Accordingly, a dynamic recording window can be automatically determined, wherein if a (dynamic) range of ambient light 2 recorded is still (substantially) changing, then recording proceeds, and if a (dynamic) range of ambient light 2 recorded is (statistically) within the range of ambient light 2 already recorded, then recording is (automatically) terminated.

In an example, the recorded parameter(s) of ambient light changes seen by the optical sensor 1 during the recording window is used to avoid mal-operation, false positive determination of arc flash event and/or nuisance-tripping of the arc flash detection system.

In an example, a user effects all possible light conditions and changes in the surrounding of the optical sensor 1, optical sensor installation, arc flash detection system and/or electrical equipment installation during the recording window.

In an example, a user triggers the initiating of a recording mode in which a first output signal of the first optical sensor 1 is recorded. In an example, a user can trigger the method for compensating for ambient light, i.e. trigger the initiating of a recording mode in which a first output signal of the first optical sensor 1 is recorded, at any time at the start (commissioning), during the (operational) life cycle of the arc flash detection system (e.g. where there is a change in ambient light condition, e.g. change of season/daylight conditions, change in room lighting etc.) and/or during changes to the arc flash detection system (e.g. addition, replacement, removal, maintenance, change of position of components such as of the optical sensors 1, 10).

Beneficially, the method as described herein can compensate for and thus is (substantially) immune to variations in ambient light 2, e.g. from variations in light source 6 types (halogen, LED, incandescent), differences/variations caused by multiple or different sensors. Beneficially, factory calibration is not needed. According to the method as described herein, a plurality of optical sensors (e.g. more than two optical sensors) (including the first optical sensor 1 and the second optical sensor 10), such as some, multiple or even all of the optical sensors for arc flash detection, in a switchyard or electrical installation (each respectively connected to a relay or protective relay), can be compensated simultaneously, at (substantially) the same time, and/or (simultaneously) by the method as described herein.

An arc flash detection system as described herein may be installed in chamber(s), compartment(s), module(s) of an electrical equipment 4 such as electrical switchboard or switchgear. The term ‘ambient light’ or; ambient light condition’ or ‘ambient light level’ may be understood as light (condition/level) in, within, around and/or surrounding the electrical equipment 4. More specific aspects and embodiments are described in the following.

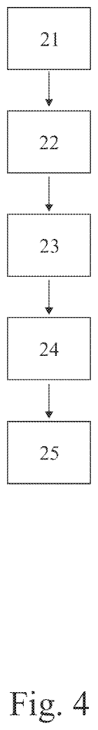

FIG. 4 illustrates an exemplary embodiment of a method for compensating for ambient light for an electrical equipment arc flash detection system according to the present disclosure. According to an embodiment, a method for compensating for ambient light for an arc flash detection system for an electrical equipment 4 comprises initiating a recording mode in which a first output signal of the first optical sensor is recorded 21, terminating the recording mode after a recording time period 23; determining, based on the first plurality of values, a first quantity characterizing ambient light in or around the electrical equipment 24; and configuring the arc flash detection system to compensate for ambient light based on the first quantity 25.

In the embodiment, recording the first output signal comprises storing a first plurality of values 22. In the embodiment, each value of the first plurality of values is representative of a level of ambient light 2 or ambient light condition in or around the electrical equipment 4. According to the embodiment, the arc flash detection system 3 includes a first optical sensor 1 for detecting an arc flash 9.

Beneficially, the optical sensor is used to effect a site specific ambient light compensation for the arc flash detection system, in particular, one that is customized exactly for the unique as-installed combination of conditions such as on-site illumination types and levels, sensor/fiber optic lengths, position and orientation as-installed, type, uncontrolled device variations, and any/all intermediate components 7 such as optical lens and/or connecting fiber optic cables (cables not used as sensors but for transmission).

According to an embodiment, the method for compensating for ambient light for an arc flash detection system for an electrical equipment 4 comprises determining a second quantity based on the first plurality of values, the second quantity in combination with the first quantity further characterizing ambient light 2 in or around the electrical equipment 4; wherein configuring the arc flash detection system to compensate for ambient light 2 is further based on the second quantity, wherein the first quantity and the second quantity are determined based on values of or values representative of a first parameter and a second parameter respectively, and wherein the first parameter is dimensionally different to the second parameter.

Beneficially, a second parameter, such as time, in addition to light intensity as the first parameter, enables a further characterization of the ambient light condition for configuring the arc flash detection system to compensate for ambient light 2. For example, ambient light dynamics can be used. For example, a rate of change of light intensity level, wherein change in light intensity level (first quantity) divided by time elapsed (second quantity) can be used to configure the arc flash detection system to compensate for ambient light 2.

In an embodiment, the first parameter is light intensity as a function of time and the second parameter is time. In an embodiment, the first quantity and the second quantity relate to the same portion of the first output signal. In an embodiment, the first quantity in combination with the second quantity characterizes an upper limit in rate of change in the ambient light level in or around the electrical equipment 4. Beneficially, a transient quality or dynamic quality of ambient light conditions can be quantified and used to configure the arc flash detection system to compensate for ambient light 2 to further increase the ambient light compensation effectiveness.

In an embodiment, the first quantity is a value representative of an upper limit of the first output signal. Beneficially, the first quantity used to configure the arc flash detection system to compensate for ambient light 2 may be tailored, for example, the first quantity may be a maximum ambient light level recorded, a 90 percent of maximum ambient light level recorded, a 110 percent of maximum ambient light level recorded, a time-averaged value, or any combination thereof.

In an embodiment, the recording time period is one of a user-defined time period, a factory pre-set time period or is defined at a point of termination of the recording mode. In an example, user interaction or user feedback is used to terminate the recording mode, such that the recording time period is defined at a point of termination of the record mode. Beneficially, further site-specific compensation may be effected, for example, personnel activities such as opening of busbar chamber, camera flash, or a worker welding nearby may be included.

In an embodiment, the first optical sensor 1 is in an installed condition in or on the electrical equipment 4 and the electrical equipment 4 is in an installed condition onsite. Beneficially, factory-defined may be avoided and ambient light compensation is made more effective.

In an embodiment, the first optical sensor 1 includes or is connected to a light transmitting component 7. In an embodiment, the light transmitting component 7 is configured to transmit light from a location of the arc flash 9 to be detected (to or from the first optical sensor 1). In an embodiment, the light transmitting component 7 is a fiber optic cable or an optical lens. Beneficially, the arc flash detection system compensates for intermediate components 7 such as optical lens and connecting fiber optic cables (cables not used as sensors but for transmission).

In an example, the first optical sensor includes or is connected to one or more light transmitting components 7. The one or more light transmitting components 7 is/are configured to transmit light from a location of the arc flash. The one or more light transmitting components 7 includes at least one of a fiber optic cable and an optical lens.

In an embodiment, the first optical sensor 1 is disposed in an enclosed compartment, and the electrical equipment 4 comprises the enclosed compartment, wherein a light source 6 is disposed in or outside the enclosed compartment, and/or wherein an access device 5 operable to block and allow physical access as well as transmission of light between outside of the enclosed compartment and inside of the enclosed compartment. Beneficially, interior compartment lighting, ambient room lighting, and opaque/semi-transparent/transparent doors/devices may be effectively compensated.

According to an embodiment, the method for compensating for ambient light for the arc flash detection system for the electrical equipment 4 further comprises outputting an arc flash event signal if a second output signal of the first optical sensor 1 is determined to not be ambient light, the second output signal being output after the arc flash detection system is configured to compensate for ambient light. Beneficially, the arc flash detection system, upon positively determining a non-nuisance/true arc flash event, triggers a protection action, such as tripping a circuit breaker.

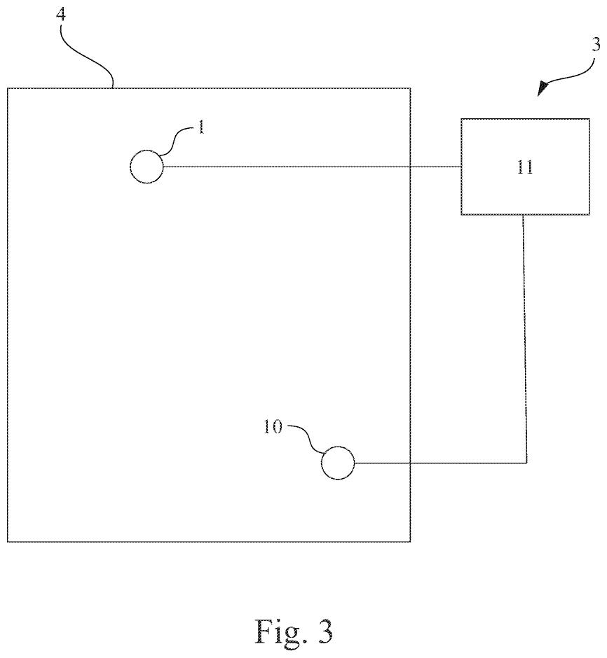

FIG. 3 illustrates an embodiment of a multi-sensor arc flash detection system according to the present disclosure. In an embodiment, the method for compensating for ambient light for the arc flash detection system for the electrical equipment 4 is carried out for a second optical sensor 10 of the arc flash detection system.

In an embodiment, the first optical sensor 1 and the second optical sensor 10 are fixedly disposed in their respective installed positions and/or orientations. In an embodiment, the electrical equipment 4 is in an installed condition on-site. In a particular embodiment, the first optical sensor 1 and the second optical sensor 10 are fixedly disposed in their respective installed positions and the electrical equipment 4 is in an installed condition on-site.

Beneficially, multiple (e.g. a subset of a plurality of optical sensors, or all of a plurality of optical sensors) as-installed on-site sensors and their respective ambient light conditions can be individually compensated for by the method as described herein. In an example, a specific combination from a plurality of optical sensors, or a subset, multiple or all of a plurality of optical sensors can be compensated for by the method as described herein. The optical sensors as described herein may be in respective as-installed conditions.

In an example, where the arc flash detection system includes a second optical sensor 10 or includes a plurality of optical sensors 1,10 for arc flash detection, initiating a recording mode 21 for each of the first optical sensor 1 and the second optical sensor 10 is triggered by a single signal. In the example, terminating the recording mode after a recording time period 23 may be triggered simultaneously, or separately. Beneficially, the method is scalable.

In the example, where the arc flash detection system includes a second optical sensor 10 or includes a plurality of optical sensors 1, 10 for arc flash detection, the method of determining, based on the first plurality of values, a first quantity characterizing ambient light 2 in or around the electrical equipment 24; and configuring the arc flash detection system to compensate for ambient light based on the first quantity 25 is performed distinctly, individually and/or separately for each of the first optical sensor 1 and the second optical sensor 10 or for each of the plurality of optical sensors 1, 10. Beneficially, the method is scalable but the unique conditions of each sensor is still individually compensated for.

In an embodiment, the first optical sensor 1 and the second optical sensor 10, or respective components 7 connected thereto, are not completely identical such that respective measurements of the same ambient light 2 resulting therefrom are not identical. Beneficially, even individual variations in the optical sensors and/or components 7 connected thereof such as fiber optic cables and optical lenses may be compensated for.

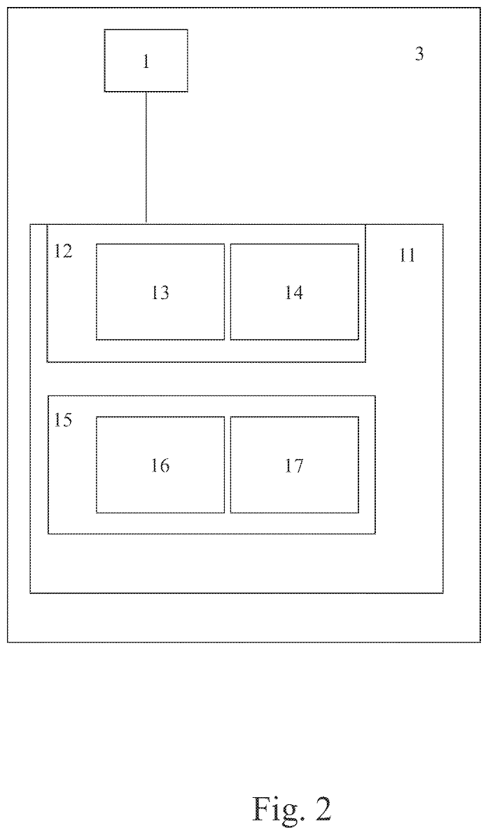

FIG. 2 illustrates an embodiment of an arc flash detection system according to the present disclosure. According to an aspect, an arc flash detection system 3 for an electrical equipment 4 is shown, the arc flash detection system comprising a data processing apparatus comprising a processor adapted to carry out the method as described herein. In an embodiment, data processing apparatus 11 comprises a communications module 12 and/or controller 15. In an example, the communications module 12 facilitates communications between the controller 15 and the various components of the arc flash detection system 3. Further, the communications module 12 may include a sensor interface 13 (e.g., one or more analog-to-digital converters) to permit signals transmitted from one or more sensors (such as the optical sensors 1, 10 described herein) to be converted into signals that can be understood and processed by the one or more processors 16. It should be appreciated that the sensors 1, 10 may be communicatively coupled to the communications module 12 using any suitable means. For example, the sensors 1, 10 are coupled to the sensor interface 13 via a wired connection.

In an example, the communications module 12 facilitates communications between the controller 15 and other components or devices of a protection function and/or in association with the protection function, such as one or more trip circuits, supervisory device and/or circuit breakers. Further, the communications module 12 may include a communications interface 14 to permit signals transmitted by controller 15 to be received by one or more trip circuits, supervisory device and/or circuit breakers. It should be appreciated that the other components or devices of a protection function and/or in association with a protection function may be communicatively coupled to the communications module 12 using any suitable means. For example, one or more trip circuits, supervisory device and/or circuit breakers are coupled to the communications interface 14 via a wired connection.

In an example, the controller 15 comprises one or more processor(s) 16 and associated memory device(s) 17 configured to perform a variety of computer-implemented functions (e.g., performing the methods, steps, calculations and the like and storing relevant data as disclosed herein).

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 17 may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 17 may generally be configured to store suitable computer-readable instructions that, when implemented by the processor(s) 16, configure the controller(s) 15 to perform various functions as described herein.

According to an aspect, a computer program comprising instructions which, when the program is executed by a computer, cause the computer to carry out the method as described herein. Beneficially, an existing arc flash detection system may be retrofitted with to perform the method for compensating for ambient light for an arc flash detection system as described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for compensating for ambient light for an arc flash detection system for an electrical equipment, the arc flash detection system including a first optical sensor for detecting an arc flash, the method comprising:
initiating a recording mode in which a first output signal of the first optical sensor is recorded, wherein recording the first output signal comprises storing a first plurality of values, and wherein each value of the first plurality of values is representative of a level of ambient light condition in or around the electrical equipment;
terminating the recording mode after a recording time period;
determining, based on the first plurality of values, a first quantity characterizing ambient light in or around the electrical equipment; and
configuring the arc flash detection system to compensate for ambient light based on the first quantity.

2. The method according to claim 1, further comprising:
determining a second quantity based on the first plurality of values, the second quantity in combination with the first quantity further characterizing ambient light in or around the electrical equipment;
wherein configuring the arc flash detection system to compensate for ambient light is further based on the second quantity;
wherein the first quantity and the second quantity are determined based on values of or values representative of a first parameter and a second parameter respectively; and
wherein the first parameter is dimensionally different to the second parameter.

3. The method according to claim 2, wherein the first parameter is light intensity as a function of time and the second parameter is time.

4. The method according to claim 2, wherein the first quantity and the second quantity relate to the same portion of the first output signal.

5. The method according to claim 4, wherein the first quantity in combination with the second quantity characterizes an upper limit in rate of change in the ambient light level in or around the electrical equipment.

6. The method according to claim 2, wherein the first quantity in combination with the second quantity characterizes an upper limit in rate of change in the ambient light level in or around the electrical equipment.

7. The method according to claim 1, wherein the first quantity is a value representative of an upper limit of the first output signal.

8. The method according to claim 7, wherein the recording time period is one of a user-defined time period, a factory pre-set time period or is defined at a point of termination of the recording mode.

9. The method according to claim 1, wherein the recording time period is one of a user-defined time period, a factory pre-set time period or is defined at a point of termination of the recording mode.

10. The method according to claim 9, wherein the first optical sensor is in an installed condition in or on the electrical equipment and the electrical equipment is in an installed condition on-site.

11. The method according to claim 1, wherein the first optical sensor is in an installed condition in or on the electrical equipment and the electrical equipment is in an installed condition on-site.

12. The method according to claim 1, wherein the first optical sensor includes or is connected to one or more light transmitting components.

13. The method according to claim 1, wherein the first optical sensor is disposed in an enclosed compartment, and the electrical equipment comprises the enclosed compartment, wherein a light source is disposed in or outside the enclosed compartment, wherein an access device operable to block and allow physical access as well as transmission of light between outside of the enclosed compartment and inside of the enclosed compartment, or wherein a light source is disposed in or outside the enclosed compartment and an access device operable to block and allow physical access as well as transmission of light between outside of the enclosed compartment and inside of the enclosed compartment.

14. The method according to claim 1, further comprising outputting an arc flash event signal when a second output signal of the first optical sensor is determined to not be ambient light, the second output signal being output after the arc flash detection system is configured to compensate for ambient light.

15. The method according to claim 1, wherein the method is carried out for a second optical sensor of the arc flash detection system.

16. The method according to claim 15, wherein the first optical sensor and the second optical sensor are not identical such that respective measurements of the same ambient light resulting therefrom are not identical.

17. The method according to claim 1, wherein the first optical sensor includes or is connected to one or more light transmitting components, wherein the one or more light transmitting components is/are configured to transmit light from a location of the arc flash, or wherein the one or more light transmitting components includes at least one of a fiber optic cable and an optical lens or wherein the one or more light transmitting components is/are configured to transmit light from a location of the arc flash and the one or more light transmitting components include at least one of a fiber optic cable or an optical lens.

18. The method according to claim 1, wherein the method is carried out for a second optical sensor of the arc flash detection system, wherein the first optical sensor and the second optical sensor are fixedly disposed in their respective installed positions, or the electrical equipment is in an installed condition on-site or wherein the first optical sensor and the second optical sensor are fixedly disposed in their respective installed positions and the electrical equipment is in an installed condition on-site.

19. An arc flash detection system for an electrical equipment, the arc flash detection system comprising a data processing apparatus comprising a processor adapted to carry out a method for compensating for ambient light for an arc flash detection system for an electrical equipment, the arc flash detection system including a first optical sensor for detecting an arc flash, the method comprising:
initiating a recording mode in which a first output signal of the first optical sensor is recorded, wherein recording the first output signal comprises storing a first plurality of values, wherein each value of the first plurality of values is representative of a level of ambient light condition in or around the electrical equipment;
terminating the recording mode after a recording time period;
determining, based on the first plurality of values, a first quantity characterizing ambient light in or around the electrical equipment; and
configuring the arc flash detection system to compensate for ambient light based on the first quantity.

20. A computer program comprising instructions which, when the program is executed by a computer, cause the computer to carry out a method for compensating for ambient light for an arc flash detection system for an electrical equipment, the arc flash detection system including a first optical sensor for detecting an arc flash, the program comprising:
instructions for initiating a recording mode in which a first output signal of the first optical sensor is recorded, wherein recording the first output signal comprises instructions for storing a first plurality of values, wherein each value of the first plurality of values is representative of a level of ambient light condition in or around the electrical equipment;
instructions for terminating the recording mode after a recording time period;
instructions for determining, based on the first plurality of values, a first quantity characterizing ambient light in or around the electrical equipment; and
instructions for configuring the arc flash detection system to compensate for ambient light based on the first quantity.
